(19) United States
(12) Patent Application Publication
(10) Pub. No.: US 2024/0282971 A1
(43) Pub. Date: Aug. 22, 2024

(54) An Electrode Assembly and A Secondary Battery

(71) Applicant: JIANGSU ZENERGY BATTERY TECHNOLOGIES CO., LTD., Changshu Suzhou City, Jiangsu (CN)

(72) Inventors: Wuyuan ZOU, Changshu Suzhou City, Jiangsu (CN); Yanlin HAN, Changshu Suzhou City, Jiangsu (CN); Wujun ZOU, Changshu Suzhou City, Jiangsu (CN); Zhexun YU, Changshu Suzhou City, Jiangsu (CN)

(21) Appl. No.: 18/569,601

(22) PCT Filed: Jun. 23, 2022
(86) PCT No.: PCT/CN2022/100687

§ 371 Date: Dec. 13, 2023

(30) Foreign Application Priority Data
Jun. 24, 2021 (CN) 202110707207.2

(51) Int. Cl. H01M 4/62; H01M 4/02; H01M 10/0525

(52) U.S. Cl. CPC H01M 4/625; H01M 10/0525; H01M 2004/021

(57) ABSTRACT

The present disclosure belongs to the technical field of electrode assemblies, and in particular, relates to an electrode assembly and a secondary battery. The electrode assembly comprises a cathode electrode plate, an anode electrode plate, and a separator, wherein the cathode electrode plate satisfies: 2.2<(a²−0.68a+1)*b/5c<31.2, and/or the anode electrode plate satisfies: 0.6<(d²−0.86d+1)*e/100f<8.2. Regarding the electrode assembly of the present disclosure, rational combination is performed according to the porosity of the cathode electrode and/or anode electrode active coating, the particle size of the active materials, and the mass percentage content of conductive carbon, so that the prepared electrode assembly and battery have a longer service life while being able to continuously provide a high-power output power.

### CROSS-REFERENCE TO RELATED APPLICATIONS

The present application is a National Stage of International Patent Application No: PCT/CN2022/100687 filed on Jun. 23, 2022, which application claims the benefit of priority to the Chinese patent application No. 202110707207.2 filed on Jun. 24, 2021, which is herein incorporated by reference in their entirety.

### TECHNICAL FIELD

The present disclosure belongs to the technical field of batteries, and in particular, to an electrode assembly and a secondary battery.

### BACKGROUND

With the improvement of global exhaust emission requirements, the transformation of power systems of automobile industry is imperative in the 21st century, and electric vehicles have become a necessary choice for transformation of energy and power systems. Since hybrid electric vehicles take both fuel consumption and emissions into account, the hybrid electric vehicles have become the mainstream of development in a relatively long period in the future, and the use of high-power batteries for hybrid electric vehicles has become the key to the development of the industry. In view of this, it is desired to provide a battery capable of continuously providing a high-power output power while maintaining a long service life.

### SUMMARY

One object of the present disclosure is: to provide an electrode assembly regarding the shortcomings of the related art, in which rational combination can be performed according to the porosity of a cathode electrode active coating or of an anode electrode active coating, the particle size of a cathode electrode active material or of an anode electrode active material, and the mass percentage content of conductive carbon in the cathode electrode active coating or the anode electrode active coating; and the electrode assembly obtained by the combination can fully utilize the performance of each component, so that the prepared battery has a longer service life and can continuously provide a high-power output power.

In order to achieve the object, the present disclosure adopts the following technical solutions:
An electrode assembly, comprising a cathode electrode plate, an anode electrode plate and a separator, wherein the separator is arranged between the cathode electrode plate and the anode electrode plate, and the separator is used to separate the cathode electrode plate from the anode electrode plate; the cathode electrode plate comprises a cathode electrode current collector and a cathode electrode active coating coated on the surface of the cathode electrode current collector, the cathode electrode active coating comprising a cathode electrode active material, a binder and conductive carbon; and the anode electrode plate comprises an anode electrode current collector and an anode electrode active coating coated on the surface of the anode electrode current collector, the anode electrode active coating comprising an anode electrode active material, a binder, a dispersant, and conductive carbon;
Wherein,
The cathode electrode plate satisfies the following relational expression:

$$2 \text{.2} < ( {a}^{2} - 0.68 a + 1 ) * b / 5 c < 3 1.2 ;$$

wherein,
a represents the porosity of the cathode electrode active coating,
b represents the particle size of the cathode electrode active material in the cathode electrode active coating, the unit being μm,
c represents the mass percentage content of the conductive carbon in the cathode electrode active coating;
And/or the anode electrode plate satisfies the following relational expression:

$$0 \text{.6} < ( {d}^{2} - 0.86 d + 1 ) * e / 100 f < 8.2 ;$$

wherein,
d represents the porosity of the anode electrode active coating,
e represents the particle size of the anode electrode active material in the anode electrode active coating, the unit being μm;
f represents the mass percentage content of the conductive carbon in the anode electrode active coating.

Further, the cathode electrode plate satisfies the following relational expression:

$$2 \text{.6} < ( {a}^{2} - 0.68 a + 1 ) * b / 5 c < 22.6 .$$

Further, the cathode electrode plate satisfies the following relational expression:

$$5 \text{.1} < ( {a}^{2} - 0.68 a + 1 ) * b / 5 c < 17.7 .$$

Further, the value of the a is: 25%≤a≤40%.

Further, the value of the a is: 30%≤a≤35%.

Further, the value of the b is: 1 μm≤b≤7 μm.

Further, the value of the b is: 2 μm≤b≤5 μm.

Further, the value of the c is: 4%≤c≤8%.

Further, the value of the c is: 5%≤c≤7%.

Further, the anode electrode plate satisfies the following relational expression:

$$0 \text{.7} < ( {d}^{2} - 0.43 d + 1 ) * e / 100 f < 7.8 .$$

Further, the anode electrode plate satisfies the following relational expression:

$$1 \text{.0} < ( {d}^{2} - 0.43 d + 1 ) * e / 100 f < 3.8 .$$

Further, the value of the d is: 35%≤d≤49%.

Further, the value of the d is: 38%≤d≤42%.

Further, the value of the e is: 3 μm≤e≤10 μm.

Further, the value of the e is: 4 μm≤e≤7 μm.

Further, the value of the f is: 1%≤f≤4%.

Further, the value of the f is: 1.5%≤f≤3%.

A second object of the present disclosure is: to provide a secondary battery regarding the shortcomings of the related art; in the battery, various components are combined rationally, the performance of each component is fully utilized, a high-power output power can be continuously provided, and the service life is long.

In order to achieve the object, the present disclosure adopts the following technical solutions:

A secondary battery, comprising the electrode assembly as stated above.

Compared with the related art, the present disclosure has the following beneficial effects: 1. Through numerous studies, the inventor has found that in an electrode assembly, the porosity of a cathode electrode active coating or of an anode electrode active coating, the particle size of a cathode electrode active material or of an anode electrode active material, and the mass percentage content of conductive carbon in the cathode electrode active coating or the anode electrode active coating, all affect the power performance of the battery to a great extent; and by rationally combining and designing the components, the power performance of the battery can be effectively improved. 2. Through many experiments, the inventor has concluded and proposed two significant empirical formulas related to electrode assembly design: 2.2<a²−0.68a+1)*b/5c<31.2, and 0.6<(d²−0.43d+1)*e/100f<8.2. During electrode assembly design, by taking the empirical formulas as guidance, regarding the cathode electrode plate and/or the anode electrode plate, the porosity of the cathode electrode active coating or of the anode electrode active coating in the electrode assembly, the particle size of the cathode electrode active material or of the anode electrode active material, and the mass percentage content of the conductive carbon in the cathode electrode active coating or the anode electrode active coating are respectively selected and designed within specific value ranges, such that the designed battery can have both excellent power performance and service life. 3. When producing and designing batteries, according to the empirical formulas, a large number of DOE experiments can be avoided, thereby saving battery research and development time and costs.

### DETAILED DESCRIPTION OF THE EMBODIMENTS

An electrode assembly, comprising a cathode electrode plate, an anode electrode plate and a separator, wherein the separator is arranged between the cathode electrode plate and the anode electrode plate, and the separator is used to separate the cathode electrode plate from the anode electrode plate; the cathode electrode plate comprises a cathode electrode current collector and a cathode electrode active coating coated on the surface of the cathode electrode current collector, the cathode electrode active coating comprising a cathode electrode active material, a binder and conductive carbon; and the anode electrode plate comprises an anode electrode current collector and an anode electrode active coating coated on the surface of the anode electrode current collector, the anode electrode active coating comprising an anode electrode active material, a binder, a dispersant, and conductive carbon;
Wherein,
The cathode electrode plates satisfy the following relational expression:

$$2 \text{.2} < ( {a}^{2} - 0.68 a + 1 ) * b / 5 c < 3 1.2 ;$$

wherein
a represents the porosity of the cathode electrode active coating,
b represents the particle size of the cathode electrode active material in the cathode electrode active coating, the unit being μm,
c represents the mass percentage content of the conductive carbon in the cathode electrode active coating;
And/or the anode electrode plate satisfies the following relational expression:

$$0 \text{.6} < ( {d}^{2} - 0.86 d + 1 ) * e / 100 f < 8.2 ;$$

wherein,
d represents the porosity of the anode electrode active coating,
e represents the particle size of the anode electrode active material in the anode electrode active coating, the unit being μm;
f represents the mass percentage content of the conductive carbon in the anode electrode active coating.

The porosity of an electrode plate comprises the porosity of the cathode electrode active coating and the porosity of the anode electrode active coating, in which the porosity of the electrode plate is a proportion of the total volume of microvoids inside the electrode plate to the total volume of the electrode plate, and the magnitude of the porosity directly reflects the compactness of the material; and the particle size of the cathode electrode active material or of the anode electrode active material and the mass percentage content of the conductive carbon in the cathode electrode active coating or the anode electrode active coating are closely related to the porosity of the electrode plate. Through numerous studies, the inventor has found that in an electrode assembly, the porosity of electrode plates, the particle size of a cathode electrode active material or of an anode electrode active material, and the mass percentage content of conductive carbon in the cathode electrode active coating or the anode electrode active coating, all affect the power performance of the battery to a great extent; and by rationally combining and designing the components, the power performance of the battery can be effectively improved. Through many experiments, the inventor has concluded and proposed two significant empirical formulas related to electrode assembly design: 2.2<a²−0.68a+1)*b/5c<31.2, and 0.6<(d²−0.43d+1)*e/100f<8.2. During electrode assembly design, by taking the empirical formulas as guidance, regarding the cathode electrode plate and/or the anode electrode plate, the porosity of electrode plates of the electrode assembly, the particle size of the cathode electrode active material or of the anode electrode active material, and the mass percentage content of the conductive carbon in the cathode electrode active coating or the anode electrode active coating are respectively selected and designed within specific value ranges, such that the designed battery can have both excellent power performance and service life. When producing and designing batteries, according to the empirical formulas, a large number of DOE experiments can be avoided, thereby saving battery research and development time and costs.

Specifically, in the formulas above, the a is the porosity of the cathode electrode plate of the electrode assembly, i.e. the porosity of the cathode electrode active coating. When the electrode assembly is charged or discharged, deintercalation and intercalation of lithium ions occur between the cathode electrode material and the anode electrode material, and the deintercalation and intercalation processes of the lithium ions are closely related to the porosity of the cathode electrode plate. On the one hand, if the porosity of the cathode electrode plate is reduced, an electron conductive network in the electrode is improved, and the internal resistance is reduced; however, if the porosity is too low, the particles of the cathode electrode active material will be in close contact with each other, an electrochemical reaction interface is reduced, and a charge transfer resistance is increased; moreover, if the porosity of the electrode plate is too low, the liquid absorption performance is reduced, and the rate performance and cycle performance of the battery deteriorate. On the other hand, if the porosity of the cathode electrode plate is increased, the infiltration of an electrolyte is good; however, an excessively high porosity may cause a poor conductive network of the electrode plate, and increase the internal resistance of the battery. Thus, the value range of the a is controlled to be 25%-40%, and more preferably, 30%≤a≤35%.

Specifically, in the formulas above, the b is the particle size of the cathode electrode active material. Reduction of the particle size of the cathode electrode active material can effectively reduce an ion transmission distance and improve the power performance of the battery; however, a too small particle size has a technical barrier and increases the dispersion difficulty of a slurry. Thus, the value range of the b is controlled to be 1 μm-7 μm, and more preferably, 2 μm≤b≤5 μm.

Specifically, in the formulas above, the c is the mass percentage content of the conductive carbon in the cathode electrode active coating. On the one hand, if the mass percentage content of the conductive carbon is too low, the conductive network in the electrode is not perfect, the internal resistance is increased, and the power performance is deteriorated; on the other hand, if the mass percentage content of the conductive carbon is too high, lithium ions will be consumed irreversibly, and the conductive carbon will occupy the proportion of the cathode electrode active material, thereby sacrificing the energy density of the battery. Therefore, the value range of the c is controlled to be 4%-8%, and more preferably 5%-7%.

Specifically, in the formulas above, the d is the porosity of the anode electrode plate of the electrode assembly, i.e. the porosity of the anode electrode active coating. On the one hand, if the porosity of the anode electrode plate is reduced, an electron conductive network in the electrode is improved, and the internal resistance is reduced; however, if the porosity is too low, the particles of the anode electrode active material will be in close contact with each other, an electrochemical reaction interface is reduced, and a charge transfer resistance is increased; moreover, if the porosity of the electrode plate is too low, the liquid absorption performance is reduced, and the rate performance and cycle performance of the battery deteriorate. On the other hand, if the porosity of the anode electrode plate is increased, the infiltration of an electrolyte is good; however, an excessively high porosity may cause a poor conductive network of the electrode plate, and increase the internal resistance of the battery. Thus, the value range of the d is controlled to be 35%-49%, and more preferably 38%≤d≤42%.

Specifically, in the formulas above, the e is the particle size of the anode electrode active material of the electrode assembly. Reduction of the particle size of the anode electrode active material can effectively reduce an ion transmission distance and improve the power performance of the battery; however, a too small particle size has a technical barrier and increases the dispersion difficulty of a slurry. Thus, the value range of the e is controlled to be 3 μm-10 μm, and more preferably, 4 μm≤b≤7 μm.

Specifically, in the formulas above, the f is the mass percentage content of the conductive carbon in the anode electrode active coating. On the one hand, if the mass percentage content of the conductive carbon is too low, the conductive network in the electrode is not perfect, the internal resistance is increased, and the power performance is deteriorated; on the other hand, if the mass percentage content of the conductive carbon is too high, lithium ions will be consumed irreversibly, and the conductive carbon will occupy the proportion of the anode electrode active material, thereby sacrificing the energy density of the battery. Thus, the value range of the f is controlled to be 1%-4%, and more preferably 1.5%-3%.

Preferably, the cathode electrode plate satisfies the following relational expression:

$$2 \text{.6} < ( {a}^{2} - 0.68 a + 1 ) * b / 5 c < 22.6 .$$

Preferably, the cathode electrode plate satisfies the following relational expression:

$$5 \text{.1} < ( {a}^{2} - 0.68 a + 1 ) * b / 5 c < 17.7 .$$

Preferably, the value of the a is: 30%≤a≤35%.

Preferably, the value of the a is: 25%≤a≤40%.

Preferably, the value of the b is: 1 μm≤b≤7 μm.

Preferably, the value of the b is: 2 μm≤b≤5 μm.

Preferably, the value of the c is: 4%≤c≤8%.

Preferably, the value of the c is: 5%≤c≤7%.

Preferably, the anode electrode plate satisfies the following relational expression:

$$0 \text{.7} < ( {d}^{2} - 0.43 d + 1 ) * e / 100 f < 7.8 .$$

Preferably, the anode electrode plate satisfies the following relational expression:

$$1 \text{.0} < ( {d}^{2} - 0.43 d + 1 ) * e / 100 f < 3 \text{.8} .$$

Preferably, the value of the d is: 35%≤d≤49%.

Preferably, the value of the d is: 38%≤d≤42%.

Preferably, the value of the e is: 3 μm≤e≤10 μm.

Preferably, the value of the e is: 4 μm≤e≤7 μm.

Preferably, the value of the f is: 1%≤f≤4%.

Preferably, the value of the f is 1.5%≤f≤3%.

Preferably, the structure of the electrode assembly is one of a prismatic battery, a cylindrical battery and a pouch battery. The electrode assembly of the present disclosure may be prepared in different structures depending on the situation, and the battery structure is not limited.

Preferably, the electrode assembly is manufactured in a wound or laminated manner. The electrode assembly of the present disclosure may select a wound or laminated manner as appropriate, and the manufacturing method is not limited.

In the electrode assembly above, the cathode electrode plate comprises a cathode electrode active material, a conductive agent, a binder, and a cathode electrode current collector. The types of the cathode electrode active material, the conductive agent, the binder and the cathode electrode current collector are not specifically limited, and can be selected according to practical requirements. For example, the cathode electrode active material may be selected from lithium cobalt oxide, lithium nickel oxide, lithium manganese oxide, lithium nickel manganese oxide, lithium nickel cobalt manganese oxide, lithium nickel cobalt aluminum oxide, lithium-containing phosphate with an olivine structure, and the like; and the cathode electrode current collector may be selected from aluminum foil, carbon-coated aluminum foil, nickel mesh, and the like.

In the electrode assembly above, the anode electrode plate comprises an anode electrode active material, a conductive agent, a binder, a dispersant, and an anode electrode current collector. The types of the anode electrode active material, the conductive agent, the binder, the dispersant, and the anode electrode current collector are not specifically limited, and may be selected according to practical requirements. For example, the anode electrode active material may be selected from graphite, soft carbon, hard carbon, mesocarbon microbeads, a silicon-based material and the like.

In the electrode assembly above, the type of the separator is not particularly limited, and may be selected according to practical requirements. For example, the separator may be selected from a polyethylene film, a polypropylene film, a polyvinylidene fluoride film, a non-woven fabric and the like; moreover, the separator may have different coating layers, for example, an alumina coating, a boehmite coating, a PVDF coating, etc.

A secondary battery, comprising the electrode assembly above, and further comprising an electrolyte and a housing.

Preferably, the electrolyte provides the battery with lithium ions that can be intercalated or deintercalated, and the lithium ions move between the cathode electrode plate and the anode electrode plate during charging and discharging of the battery, thereby providing electric energy to the outside. The electrolyte comprises a lithium salt solute and a solvent. The types of the lithium salt and the solvent are both not specifically limited, and may be selected according to practical requirements. For example, the lithium salt may be selected from LiPF₆, LiTFSI, LIBF₄ and the like.

The material of the housing comprises, but is not limited to, an aluminum plastic film, an aluminum plate, and a tin plate.

The present disclosure will be further described in detail below in conjunction with specific embodiments, but embodiments of the present disclosure are not limited thereto.

The present disclosure is further illustrated below by taking a prismatic electrode assembly as an Embodiment in combination with specific embodiments. In Embodiments, preparation and testing were performed according to the following method.

### Embodiment 1

### 1. Preparation of an Anode Electrode Plate

Mixing an anode electrode active material, i.e. graphite, a conductive carbon SP, a binder LA133 and a dispersant CMC at a certain mass ratio, adding deionized water, and stirring same with a homogenizer to form a uniformly and stably mixed slurry; uniformly coating the resulting slurry on an anode electrode current collector, i.e. a copper foil, drying and cold pressing same for standby use.

### 2. Preparation of a Cathode Electrode Plate

Mixing a cathode electrode active material NCM111, conductive carbon SP and a binder PVDF at a certain mass ratio, then adding NMP (N-methyl pyrrolidone), and stirring with a homogenizer to form a uniformly and stably mixed slurry; and uniformly coating the resulting slurry on a current collector, i.e. an aluminum foil, drying and cold pressing same for standby use.

### 3. Preparation of an Electrolyte

Mixing ethylene carbonate (EC), ethyl methyl carbonate (EMC) and diethyl carbonate (DEC) at a volume ratio of 1:1:1 to obtain an organic solvent, and then dissolving a fully-dried lithium salt LiPF₆ in the mixed organic solvent, to formulate an electrolyte with a concentration of 1.2 mol/L.

### 4. Selection and Preparation of a Separator

A polypropylene film having a thickness of 16 μm was selected as the separator.

### 5. Preparation of an Electrode Assembly

sequentially stacking the cathode electrode plate, the separator and the anode electrode plate, so that the separator was located between the cathode electrode plate and the anode electrode plate to achieve a separation effect, and then winding same to obtain a cell; placing the cell in an outer packaging housing, drying and then injecting an electrolyte, and performing processes such as vacuum packaging, standing, forming, shaping, etc., so as to obtain a 8 Ah electrode assembly.

With reference to Embodiment 1, Embodiments 2-8 were further prepared, which differed from Embodiment 1 in respect of: parameters of the porosity of the anode electrode plate, the particle size of the cathode electrode active material, and the mass percentage content of the conductive carbon; the specific settings were as shown in Table 1. The electrode assemblies prepared in Embodiments 1-8 were subjected to performance test, in which the test method was: at 25° C., the electrode assembly was fully charged with a constant current and a constant voltage by a 1 C current; after standing for 5 min, the electrode assembly was discharged by 1 C for 48 min; and after standing for 5 min, an output discharging time when discharging the electrode assembly to 2.5 V by 1045 W was calculated. Specific data parameters and test results were shown in Table 1 below.

TABLE 1

| | | Particle size | Mass | | |
|---|---|---|---|---|---|
| | Porosity of | of cathode | percentage | | |
| | cathode | electrode | content of | (a² − | |
| | electrode | active | conductive | 0.68 a + | |
| | plate, | material, | carbon, | 1)*b/5 | 1045 W |
| Embodiment | i.e. a | i.e. b | i.e. c | c | DC/s |
| 1 | 35.5% | 2.45 | 5.5% | 7.88 | 8 |
| 2 | 34.3% | 2.31 | 6.5% | 6.29 | 11.4 |
| 3 | 34.6% | 2.31 | 6.0% | 6.81 | 10.5 |
| 4 | 31.8% | 2.42 | 5.5% | 7.79 | 10.3 |
| 5 | 29.5% | 2.42 | 5.5% | 7.80 | 9.4 |
| 6 | 27.2% | 2.42 | 5.5% | 7.82 | 8.5 |
| 7 | 33.1% | 2.42 | 4.5% | 9.51 | 7.4 |
| 8 | 31.0% | 2.42 | 6.5% | 6.59 | 10.6 |

It could be determined from Table 1 that in Embodiment 1, the discharging time of discharging to 2.5 V under a high power of 1045 W could last for 8 s, and the output time at a large power was relatively short; it could be obtained that in Embodiment 1, the design and combination of the porosity of the cathode electrode plate, the particle size of the cathode electrode active material and the mass percentage content of the conductive carbon were not rational enough, in which the porosity of the cathode electrode plate was too high, a conductive network of the electrode plate deteriorates, and the internal resistance of the lithium battery was increased, thereby deteriorating the power performance of the electrode assembly. By the same reasoning, in Embodiment 6, the discharging time of discharging to 2.5 V under a high power of 1045 W could last for 8.5 s, and the output time at a large power was relatively short; it could be obtained that in Embodiment 6, the design and combination of the porosity of the cathode electrode plate, the particle size of the cathode electrode active material and the mass percentage content of the conductive carbon were not rational enough, in which the porosity of the cathode electrode plate was too low, and a charge transfer resistance of the electrode plate was increased, thereby deteriorating the power performance of the electrode assembly. In Embodiment 7, the discharging time of discharging to 2.5 V under a high power of 1045 W can last for 7.4 s, and the output time at a large power was relatively short; it could be obtained that in Embodiment 7, the design and combination of the porosity of the cathode electrode plate, the particle size of the cathode electrode active material and the mass percentage content of the conductive carbon were not rational, in which the mass percentage content of the conductive carbon was too low, a conductive network of the electrode plate deteriorates, and the internal resistance of the lithium battery was increased, thereby deteriorating the power performance of the electrode assembly. However, when the porosity of the cathode electrode plate, the particle size of the cathode electrode active material and the mass percentage content of the conductive carbon were set as those in Embodiment 2, that was, when the porosity of the cathode electrode plate was 34.3%, the particle size of the cathode electrode active material was 2.31 μm, and the mass percentage content of the conductive carbon was 6.5%, the discharging time of discharging to 2.5 V under a high power of 1045 W could last for 11.4 s, and the output time at a large power was relatively long, which improved by 54% compared with the high-power discharging time of Embodiment 7 and had significant progress. Preferably, by comparing different porosities of the cathode electrode plate, different particle sizes of the cathode electrode active material and different mass percentage contents of the conductive carbon and rationally designing the relationship between the three such that the relationship between the three satisfied 5.1<a²−0.68a+1)*b/5c<17.7, for Embodiment, Embodiments 2, 3, 4 and 8, the power performance of the electrode assembly could be significantly improved.

Embodiment 9 differed from Embodiment 1 in that: the present disclosure changes parameters of the anode electrode plate.

Embodiments 10-16 were prepared according to the preparation method of Embodiment 9, and differed from Embodiment 9 in respect of: parameters of the porosity of the anode electrode plate, the particle size of the anode electrode active material, and the mass percentage content of the conductive carbon. The electrode assemblies prepared in Embodiments 9-16 were subjected to performance test, in which the test method was: at 25° C., the electrode assembly was fully charged with a constant current and a constant voltage by a 1 C current; after standing for 5 min, the electrode assembly was discharged by 1 C for 48 min; and after standing for 5 min, an output discharging time when discharging the electrode assembly to 2.5 V by 1045 W was calculated. Specific data parameters were as shown in Table 2.

TABLE 2

| | | Particle size | Mass | | |
|---|---|---|---|---|---|
| | Porosity | of anode | percentage | | |
| | of anode | electrode | content of | | |
| | electrode | active | conductive | (d² − | |
| | plate, | material, | carbon, | 0.86d + 1) | 1045 W |
| Embodiment | i.e. d | i.e. e | i.e. f | *e/100f | DC/s |
| 9 | 38.0% | 8.00 | 2.0% | 3.27 | 8.6 |
| 10 | 38.3% | 6.13 | 2.0% | 2.51 | 11.4 |
| 11 | 41.0% | 6.13 | 1.5% | 3.33 | 9.0 |
| 12 | 40.5% | 6.63 | 2.0% | 2.70 | 10.3 |
| 13 | 42.7% | 6.63 | 2.0% | 2.70 | 9.4 |
| 14 | 42.7% | 6.63 | 2.0% | 2.70 | 8.5 |
| 15 | 46.0% | 6.16 | 2.0% | 2.51 | 8.7 |
| 16 | 42.7% | 5.5 | 2.5% | 1.79 | 12.0 |

It could be determined from Table 2 that in Embodiment 9, the discharging time of discharging to 2.5 V under a high power of 1045 W could last for 8.6 s, and the output time at a large power was relatively short; the design and combination of the porosity of the anode electrode plate, the particle size of the anode electrode active material and the mass percentage content of the conductive carbon were unreasonable: the particle size of the anode electrode active material was too large, an ion transmission path was increased, and the power performance of the electrode assembly deteriorates. In Embodiment 15, the discharging time of discharging to 2.5 V under a high power of 1045 W could last for 8.7 s, and the output time at a large power was relatively short; the design and combination of the porosity of the anode electrode plate, the particle size of the anode electrode active material and the mass percentage content of the conductive carbon were not rational, in which the porosity of the anode electrode plate was too high, a conductive network of the electrode plate deteriorates, and the internal resistance of the battery was increased, thereby deteriorating the power performance of the electrode assembly. However, when the porosity of the anode electrode plate, the particle size of the anode electrode active material and the mass percentage content of the conductive carbon were set as those in Embodiment 16, that was, when the porosity of the anode electrode plate was 42.7%, the particle size of the anode electrode active material was 5.5 μm, and the mass percentage content of the conductive carbon was 2.5%, the discharging time of discharging to 2.5 V under a high power of 1045 W could last for 12 s, and the output time at a large power is relatively long, which improves by 37.9% compared with the high-power discharging time of Embodiment 15 and had significant progress. In Embodiments 9-16 of Table 2 above, by comparing different porosities of the anode electrode plate, different particle sizes of the anode electrode active material and different mass percentage contents of the conductive carbon and rationally designing the relationship between the three such that the relationship between the three satisfied 1.0<d²−0.43d+1)*e/100f<3.8, for Embodiment, Embodiments 10, 12 and 16, the power performance of the electrode assembly could be significantly improved.

According to the disclosure and teaching of the description above, a person skilled in the field to which the present disclosure belongs would also have been able to make changes and modifications to the embodiments above. Therefore, the present disclosure is not limited to the described specific embodiments, and any obvious improvements, replacements or modifications made by a person skilled in the art on the basis of the present disclosure shall all belong to the scope of protection of the present disclosure. In addition, although some specific terms are used in the present description, these terms are merely used for convenience of illustration and do not constitute any limitation on the present disclosure.

1. An electrode assembly, comprising: a cathode electrode plate, an anode electrode plate and a separator, wherein the separator is arranged between the cathode electrode plate and the anode electrode plate, and the separator is used to separate the cathode electrode plate from the anode electrode plate; the cathode electrode plate comprises a cathode electrode current collector and a cathode electrode active coating coated on the surface of the cathode electrode current collector, the cathode electrode active coating comprising a cathode electrode active material, a binder and conductive carbon; and the anode electrode plate comprises an anode electrode current collector and an anode electrode active coating coated on the surface of the anode electrode current collector, the anode electrode active coating comprising an anode electrode active material, a binder, a dispersant, and conductive carbon; wherein
the cathode electrode plate satisfies the following relational expression:
$$2 \text{.2} < ( {a}^{2} - 0.68 a + 1 ) * b / 5 c < 3 1.2 ;$$
a represents the porosity of the cathode electrode active coating,
b represents the particle size of the cathode electrode active material in the cathode electrode active coating, the unit being μm,
c represents the mass percentage content of the conductive carbon in the cathode electrode active coating;
and/or
the anode electrode plate satisfies the following relational expression:
$$0 \text{.6} < ( {d}^{2} - 0.86 d + 1 ) * e / 100 f < 8.2 ;$$
d represents the porosity of the anode electrode active coating,
e represents the particle size of the anode electrode active material in the anode electrode active coating, the unit being μm;
f represents the mass percentage content of the conductive carbon in the anode electrode active coating.

2. The electrode assembly according to claim 1, wherein the cathode electrode plate satisfies the following relational expression: 2.6<(a²−0.68a+1)*b/5c<22.6.

3. The electrode assembly according to claim 2, wherein the cathode electrode plate satisfies the following relational expression: 5.1<(a²−0.68a+1)*b/5c<17.7.

4. The electrode assembly according to claim 1, wherein the value of the a is: 25%≤a≤40%;
and/or the value of the b is: 1 μm≤b≤7 μm;
and/or the value of the c is: 4%≤c≤8%.

5. (canceled)

6. (canceled)

7. The electrode assembly according to claim 1, wherein the anode electrode plate satisfies the following relational expression: 0.7<(d²−0.43d+1)*e/100f<7.8.

8. The electrode assembly according to claim 7, wherein the anode electrode plate satisfies the following relational expression: 1.0<(d²−0.43d+1)*e/100f<3.8.

9. The electrode assembly according to claim 1, wherein the value of the d is: 35%≤d≤49%.

10. The electrode assembly according to claim 1, wherein the value of the e is: 3 μm≤e≤10 μm.

11. The electrode assembly according to claim 1, wherein the value of the f is: 1%≤f≤4%.

12. A secondary battery, comprising the electrode assembly according to claim 1.

13. The electrode assembly according to claim 2, wherein the value of the a is: 25%≤a≤40%;
and/or the value of the b is: 1 μm≤b≤7 μm;
and/or the value of the c is: 4%≤c≤8%.

14. The electrode assembly according to claim 3, wherein the value of the a is: 25%≤a≤40%;
and/or the value of the b is: 1 μm≤b≤7 μm;
and/or the value of the c is: 4%≤c≤8%.

15. The electrode assembly according to claim 7, wherein the value of the d is: 35%≤d≤49%.

16. The electrode assembly according to claim 8, wherein the value of the d is: 35%≤d≤49%.

17. The electrode assembly according to claim 7, wherein the value of the e is: 3 μm≤e≤10 μm.

18. The electrode assembly according to claim 8, wherein the value of the e is: 3 μm≤e≤10 μm.

19. The electrode assembly according to claim 7, wherein the value of the f is: 1%≤f≤4%.

20. The electrode assembly according to claim 8, wherein the value of the f is: 1%≤f≤4%.

21. A secondary battery, comprising the electrode assembly according to claim 2.

22. A secondary battery, comprising the electrode assembly according to claim 3.
